(19) United States
(12) Patent Application Publication
(10) Pub. No.: US 2016/0321458 A1
(43) Pub. Date: Nov. 3, 2016

(54) SYSTEMS AND METHODS FOR SECURED DATA TRANSFER VIA INTER-CHIP HOPPING BUSES

(71) Applicant: Marvell World Trade Ltd., St. Michael (BB)

(72) Inventor: Minda Zhang, Westford, MA (US)

(21) Appl. No.: 15/048,135

(22) Filed: Feb. 19, 2016

Related U.S. Application Data
(60) Provisional application No. 62/156,094, filed on May 1, 2015.

(51) Int. Cl. G06F 21/60; H04L 9/06; H04L 9/32

(52) U.S. Cl. CPC G06F 21/606; H04L 9/3236; H04L 9/0643

(57) ABSTRACT

Systems and methods described herein provide a method for secured data transfer via inter-chip hopping buses. The method includes configuring a non-volatile storage element located within a first electronic component to be pre-programmed with a first unique identifier associated with a first electronic component. The method further includes configuring a first scramble pattern generator located within the first electronic component for generating a first scramble pattern based on a first counter value at runtime of the first electronic component. The method further includes configuring a first XOR gate located within the first electronic component to receive the first scramble pattern from the first scramble pattern generator and data from a transceiver buffer for generating output data to be transmitted out of the first electronic component.

### CROSS-REFERENCE TO RELATED APPLICATION

This disclosure claims the benefit of copending, commonly-assigned U.S. Provisional Patent Application No. 62/156,094, filed May 1, 2015, which is hereby incorporated by reference herein in its entirety.

### FIELD OF USE

This disclosure relates to secured data transfer via inter-chip hopping buses, for example, on an integrated circuit board.

### BACKGROUND OF THE DISCLOSURE

The background description provided herein is for the purpose of generally presenting the context of the disclosure. Work of the inventors hereof, to the extent the work is described in this background section, as well as aspects of the description that may not otherwise qualify as prior art at the time of filing, are neither expressly nor impliedly admitted to be prior art against the present disclosure.

On a printed circuit board, multiple electronic components can often be mechanically supported and electrically connected to perform data processing tasks. For example, a multimedia processing chip may receive encrypted multimedia data from a communication chip in order to process and then display multimedia content via a user interface. The multimedia processing chip may decrypt the received data and send the decrypted data back to the communication chip to transmit to a display component. If probing circuitry is added to the communication chip, the decrypted data may be intercepted by the probing circuitry. Thus, the originally encrypted multimedia data may be exposed to a third party by the probing circuitry and the data security of the circuit is damaged.

### SUMMARY

Systems and methods described herein provide a method for secured data transfer via inter-chip hopping buses. The method includes configuring a non-volatile storage element located within a first electronic component to be pre-programmed with a first unique identifier associated with a first electronic component. The method further includes configuring a first scramble pattern generator located within the first electronic component for generating a first scramble pattern based on a first counter value at runtime of the first electronic component. The method further includes configuring a first XOR gate located within the first electronic component to receive the first scramble pattern from the first scramble pattern generator and data from a transceiver buffer for generating output data to be transmitted out of the first electronic component.

In some implementations, the non-volatile storage element includes a fuse block or a one-time programmed element, and the non-volatile storage element is further pre-programmed with a common transit key during a manufacturing phase.

In some implementations, the non-volatile storage element is further programmed with a hash digest computed based on the list of the unique identifier of each chip on the PCB (Print-Circuit-Board), and after being programmed with the hash digest, the non-volatile storage element is locked to prevent unwanted change.

In some implementations, the hash digest is used to authenticate all the chips mounted on the PCB by comparing with a newly computed hash digest, and wherein the authentication is performed during a manufacturing phase, a testing phase, or an initialization phase of the device.

In some implementations, the output data is received at a second electronic component communicatively coupled to the first electronic component via an inter-chip bus; and wherein the second electronic component comprises a second scramble pattern generator to generate a second scramble pattern based on a second counter value, wherein the second counter value is synchronized with the first counter value.

In some implementations, the second electronic component further comprises a second XOR gate to receive the second scramble pattern from the second scramble pattern generator and data received from the first electronic component to generate output data to be enter a receiver buffer at the second electronic component.

In some implementations, the second counter value is synchronized with the first counter value, and the second scramble pattern is synchronized with the first scramble pattern.

In some implementations, the first scramble pattern generator generates a new bit pattern based on a sync pattern cryptographically created using a first encryption key at a variable rate.

In some implementations, the first scramble pattern generator periodically generates a new bit pattern based on a sync pattern cryptographically created using a first encryption key when the first scramble counter value reaches a pre-defined count.

Systems and methods described in some embodiments provide circuitry for secured data transfer via inter-chip hopping buses. The circuitry includes a non-volatile storage element to be pre-programmed with a first unique identifier associated with the first electronic component. The circuitry further includes a first scramble pattern generator to generate a first scramble pattern based on a first counter value at runtime of the first electronic component. The circuitry further includes a first XOR gate to receive the first scramble pattern from the first scramble pattern generator and data from a transceiver buffer to generate output data to be transmitted out of the first electronic component.

Systems and methods described in some embodiments provide a method for secured data transfer via inter-chip hopping buses. The method includes configuring a non-volatile storage element located within an electronic component to be pre-programmed with a unique identifier associated with an electronic component and a transit key. The method further includes configuring a scramble pattern generator located within the electronic component for generating a scramble pattern based on a counter value at runtime of the electronic component. The method further includes configuring a transceiver component or a receiver component locate within the electronic component based on an inter-chip communication protocol to transmit a set of control packets to enforce security check and to setup inter-chip secure communication. The inter-chip communication protocol includes a set of signal bits defined in a header frame and an acknowledgement frame to establish a synchronized data scrambling mechanism for the scramble pattern generator. The method further includes configuring an encryption component located within the electronic component to encrypt the unique identifier using the transit key and to send the encrypted first unique identifier to another electronic component.

In some implementations, the inter-chip communication protocol includes a public key infrastructure (PKI) scheme to establish secure communication channels, and wherein the PKI scheme supports real-time and on-demand addition of a new electronic component.

### BRIEF DESCRIPTION OF THE DRAWINGS

Further features of the disclosure, its nature and various advantages will become apparent upon consideration of the following detailed description, taken in conjunction with the accompanying drawings, in which like reference characters refer to like parts throughout, and in which:

FIG. 1A provides an exemplary block diagram illustrating Inter-Chip Hopping Bus(IHB) security components within a multi-die-based architecture (MDBA) platform in accordance with various embodiments of this disclosure.

FIGS. 1B-C provide exemplary block diagrams illustrating detailed structural components of electronic components 100 and 101 in FIG. 1A, and the data transfer therebetween in accordance with various embodiments of this disclosure.

FIG. 2 provides a logic flow diagram illustrating an example work process of secured data transfer with enhanced IHB security in accordance with various embodiments of this disclosure.

FIGS. 3A and 3B provide an example block diagram illustrating a modified IHB packet format for the enhanced IHB security in accordance with various embodiments of this disclosure.

FIG. 4 provides an example block diagram illustrating the data format of an IHB command for security check, AES key setup and/or scramble pattern initialization in accordance with various embodiments of this disclosure.

FIGS. 5A and 5B provides an example block diagram illustrating the scrambling process between two electronic components, e.g., chip #0 100 and chip #1 101 in accordance with various embodiments of this disclosure.

FIG. 6 provides an example block diagram illustrating an IHB security module available for hot plug-in in accordance with various embodiments of this disclosure.

### DETAILED DESCRIPTION

This disclosure describes methods and systems for a mechanism to securely transfer data between electronic components via inter-chip hopping buses (IHBs) on a motherboard. Specifically, an IHB security module within an electronic component can generate a scramble pattern to scramble data to be sent or de-scramble received data. The transceiver component and the receiver component synchronously generate and use a scramble pattern for encryption or decryption, respectively, such that the receiver component can de-scramble the secured data packets received from the transceiver.

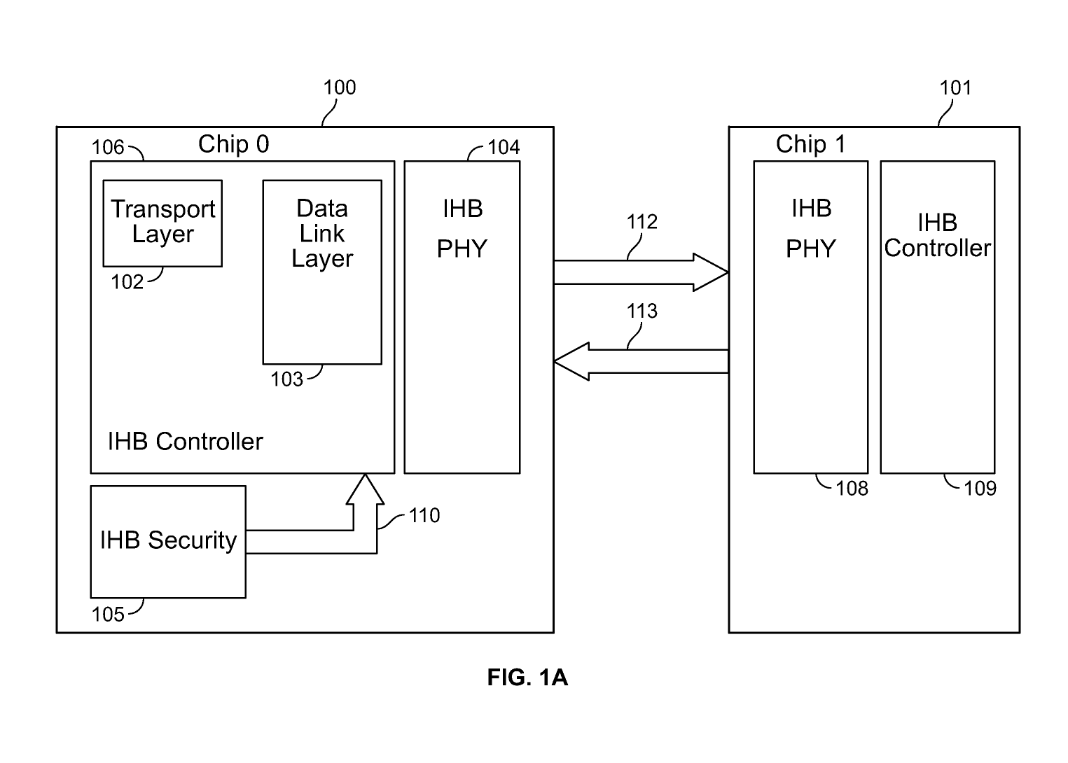

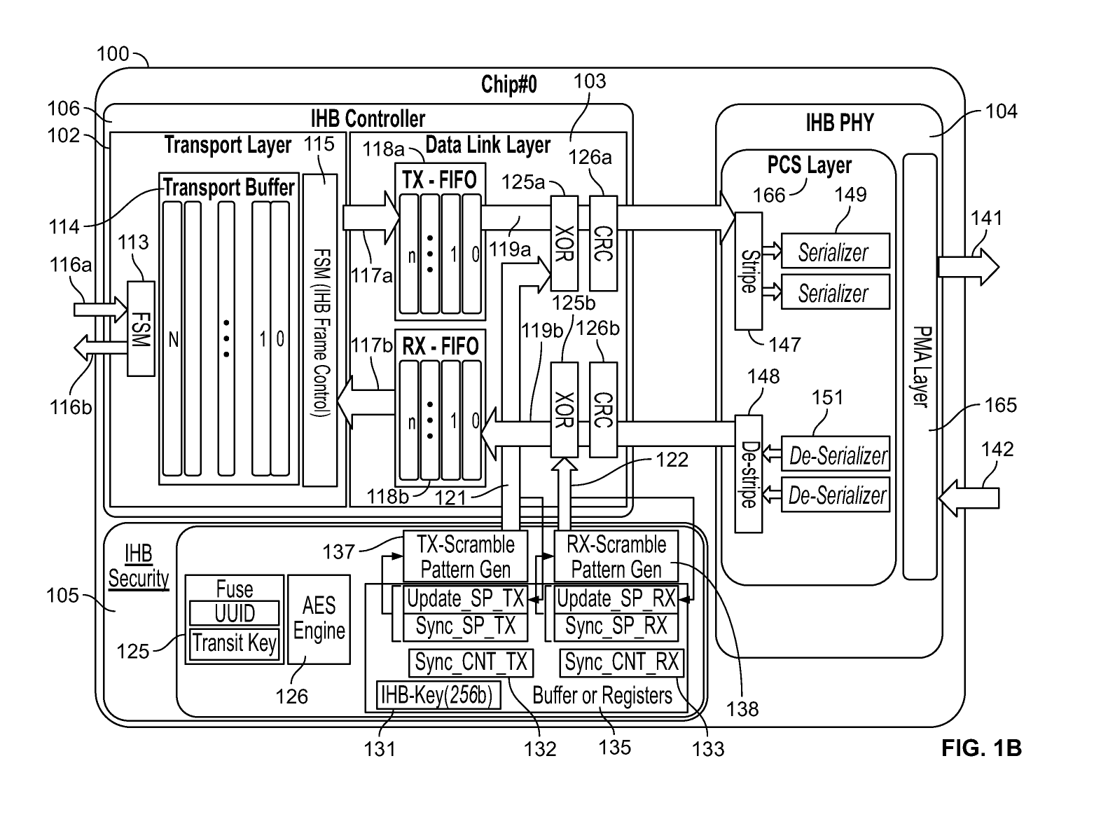

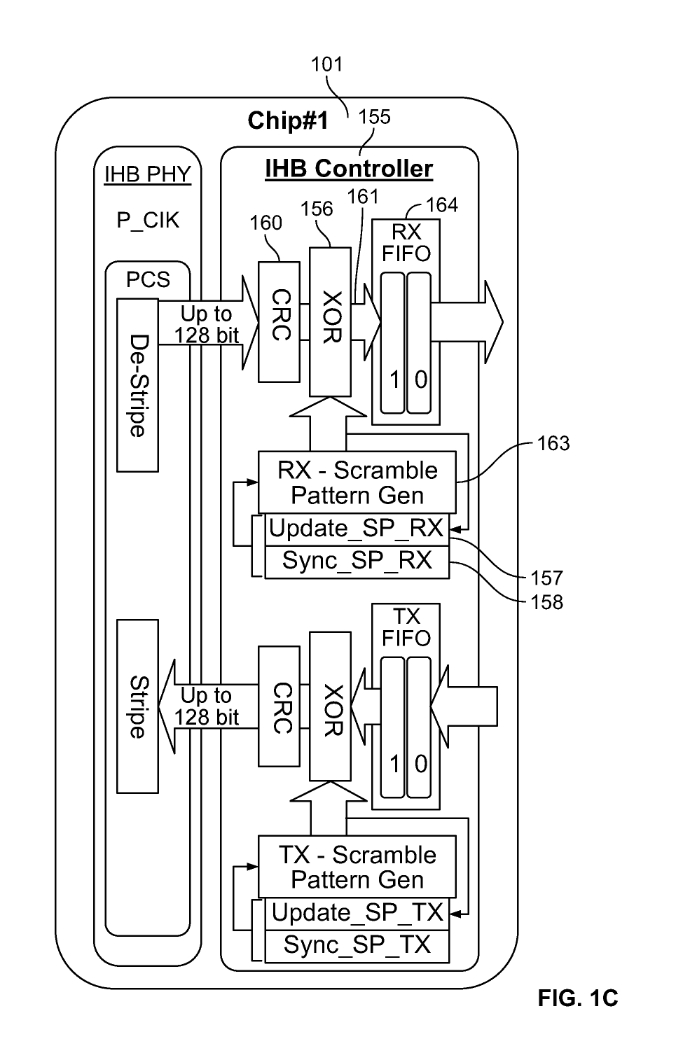

FIG. 1A provides an exemplary block diagram illustrating IHB security components within a multi-device-based architecture (MDBA) platform. As shown in FIG. 1A, multiple electronic components, such as chip #0 100 and chip #1 101, may be connected via IHB on a motherboard. For example, chip #0 100 can be a master chip such as a multimedia processor and/or the like, and chip #1 101 can be a communication chip that streams multimedia data to chip #0 100.

Chip #0 100 may have an IHB physical layer 104 that includes a transceiver and a receiver to transmit data 112 to or receive data 113 from the IHB physical layer 108 of chip #1 101. The received data at chip #0 100 can be processed by the IHB controller 106, which passes the data via a transport layer 102 and a data link layer 103. Similarly, at chip #1 101, an IHB controller 109 controls the data transmission and processing.

An IHB security module 105 can be employed to provide secured data 110 to be transmitted to chip #1 101, as further discussed in FIG. 1B.

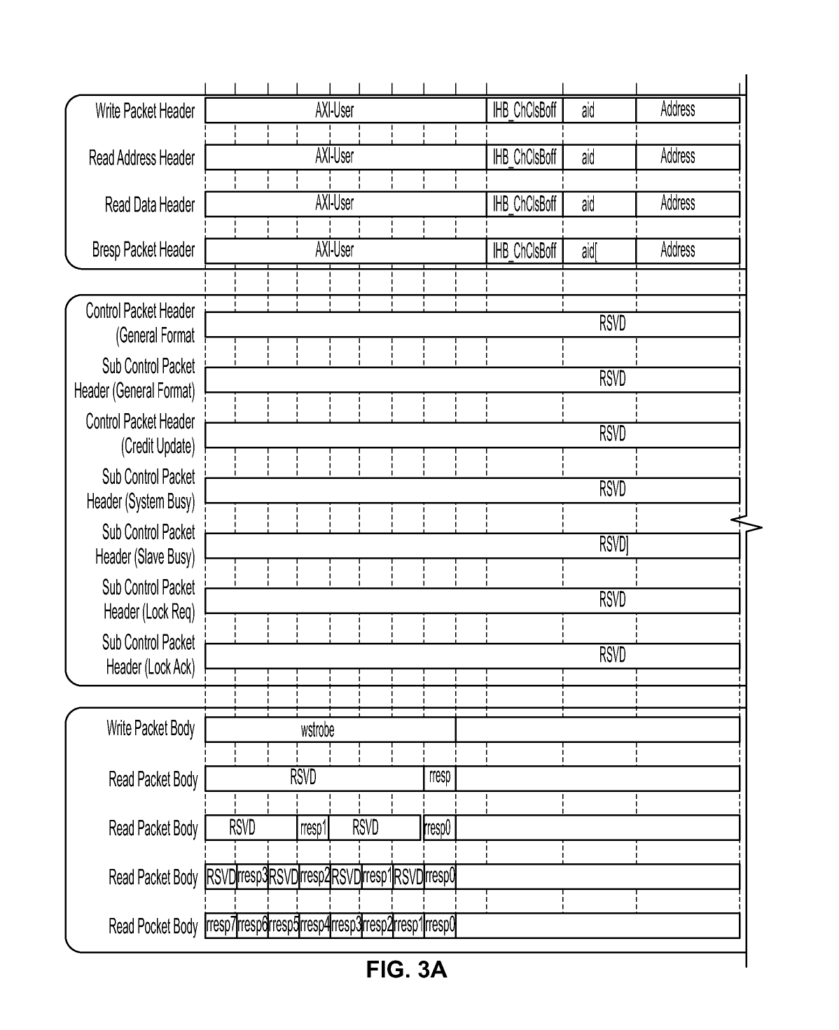

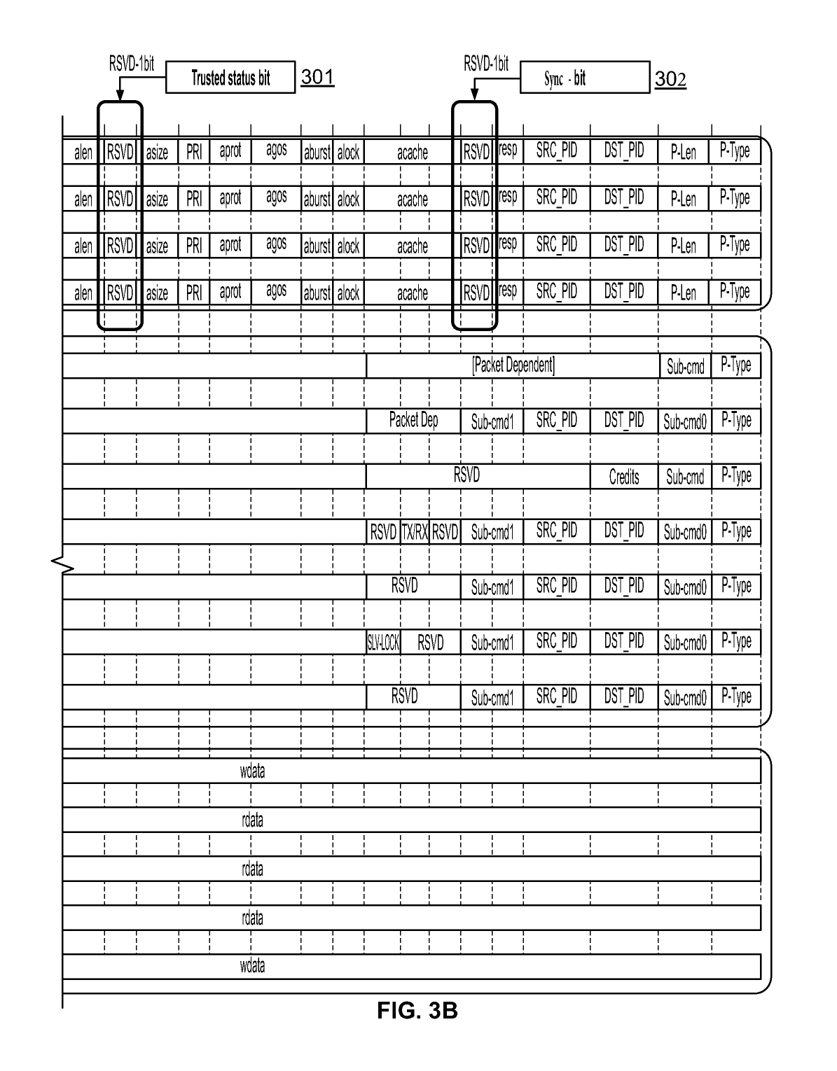

FIGS. 1B and 1C provide exemplary block diagrams illustrating detailed structural components of electronic components 100 and 101 in FIG. 1A, and the data transfer therebetween in accordance with various embodiments of this disclosure. The IHB controller 106 may operate at a clock rate of 1 GHz. The transport layer 102 may read or write data 116a or 116b, respectively, from another on chip component (not shown in FIG. 1B) via a finite state machine (FSM) bridge 113. The data may be temporarily stored at a transport buffer 114 before being sent the data link layer 103. An FSM 115 is employed between the transport layer 102 and the data link layer 103 for IHB frame control. At the FSM 115, a trusted bit (e.g., 301 in FIG. 3B) and/or a synchronization bit can be added to an packet header frame, once IHB security component 105 establishes the power-on-device AES key, and/or generates a new scrambling sync-pattern. The data 117a-b transferred between the transport layer 102 and the data link layer 103 may be header packet frame, data packet frame, as well as other control packet frame at high clock rate.

At the data link layer 103, a transceiver first-in-first-out (FIFO) buffer 119a or a receiver FIFO buffer 119b can be employed for buffering data to be transmitted or received. The output data 119a of the transceiver FIFO buffer 118a, together with a transceiver scrambled pattern 121 (e.g., up to 128-bit) obtained from the IHB security module 105, can be applied to an XOR logic gate (e.g., up to 128-bit). The output of the XOR gate 125a can then be passed to a cyclic redundancy check (CRC) component 126a, before being sent to the IHB physical layer 104. Similarly, any data input to the CRC component 126b from the IHB physical layer 104 is fed into an XOR logic gate 125b together with a receiver scrambled pattern 122 obtained from the IHB security module 105. In this way, the output of the XOR logic gate 125b is then loaded to the receiver FIFO buffer 118b.

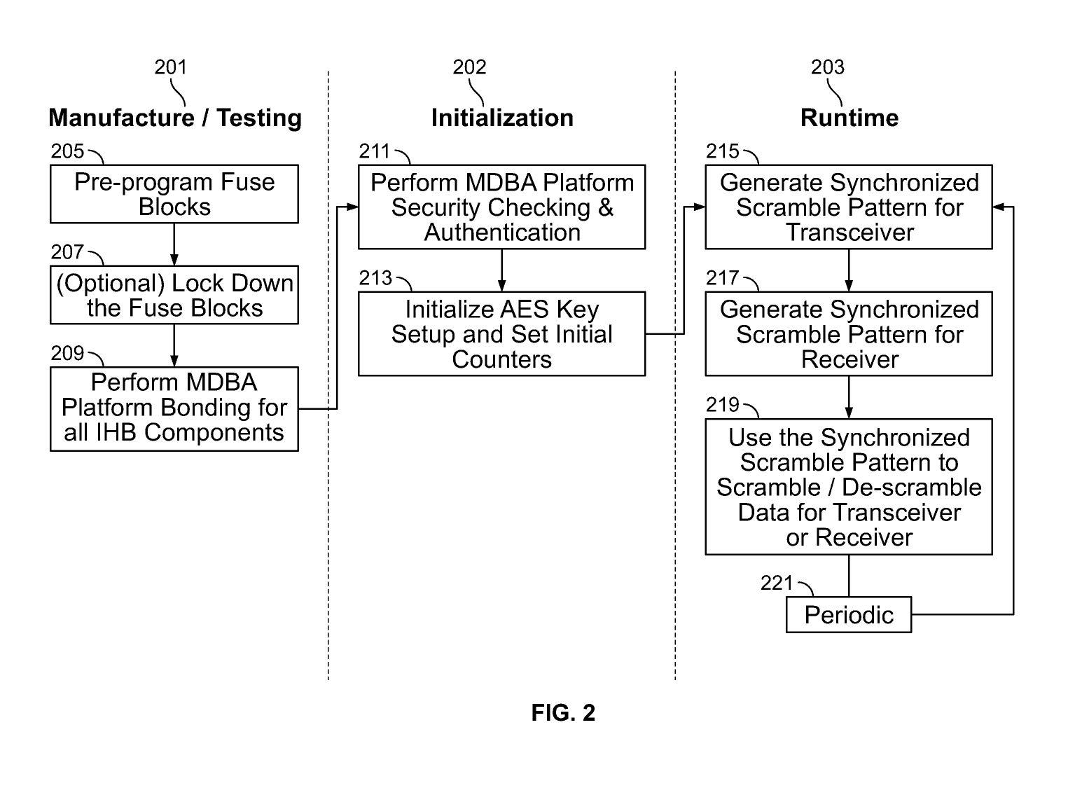

The IHB security module 105 may operate at a clock rate in synchronization with the one used for data output 119a of the transceiver FIFO buffer 118a, or the data input 119b to the receiver FIFO buffer 118b. The IHB security module 105 includes a fuse storage element 125 that has been pre-programmed with a universally unique identifier (UUID) and a transit encryption key. For example, the UUID (e.g., 64-bit) is configured to be globally unique across IHB security modules on different electronic components. The transit encryption key (e.g., 256-bit, etc.) can be pre-programmed by a manufacturer, e.g., see 205 in FIG. 2.

The IHB security module 105 further includes scramble pattern generators 137-138 when chip #0 100 is serving as a transceiver or a receiver, respectively. The scramble pattern generators 137-138 generate scramble patterns 121-122 to be fed to the XOR gates 125a-b, respectively, as further discussed in FIG. 2.

At the physical coding sublayer 166 (PCS) of the IHB physical layer 104, the data to be sent when chip #0 100 acts as a transceiver is processed at the stripe interface 147 before sending to the serializer 149. Similarly, the received data when chip #0 100 acts as a receiver is de-serialized at the de-serializer 151 and de-striped at 148. A physical medium attachment (PMA) layer 165 receives data 142 or sends data 141 to another IHB component, e.g., chip #1 101.

As shown in FIG. 1C, chip #1 101 comprises similar modules as in chip #0 100, including but not limited to a XOR gate 156, a CRC module 160, and receiver FIFO buffer 164. Further interaction between two IHB components, e.g., chip #0 100 and chip #1 101, are discussed in connection with FIG. 2.

FIG. 2 provides a logic flow diagram illustrating an example work process of secured data transfer with enhanced IHB security in accordance with various embodiments of this disclosure. At the manufacturing/testing phase 201, a testing procedure may be applied to program the UUID and transit key into their respective fuse blocks (e.g., 125 in FIG. 1B) at 205 during IHB chip manufacturing process, and lock down the fuse block at 207. For example, to implement the testing procedure 205, all transit keys that may be pre-programmed in each IHB chip may be of the same value. Once all IHB chips are mounted to a printed circuit board (PCB), the master IHB chip (e.g., the first IHB chip released at reset after the MDBA platform is powered up) may issue an IHB command packet frame broadcasting to all IHB chips within the MDBA platform. The master IHB chip may then get each UUID of the respective IHB chip, and ciphertext of the UUID encrypted by AES using the transit key. In this way, the master IHB chip can validate whether the pre-programmed transit key in the FUSE block within each IHB chip is valid. If the transit encryption key is not blown or found the ciphertext of the UUID is incorrect, the respective electronic component (e.g., the data link layer 103 in FIG. 1B) is not qualified for running under the IHB trusted mode in data transferring.

Upon the fuse block having been pre-programmed, MDBA platform bonding process can be performed at 209, e.g., by a device manufacturer during the device manufacturing phase. For example, to perform the bonding process on an MDBA platform, a security IP module within the master IHB chip of MBDA platform can compute a hash digest over a data file that lists all the UUIDs, which includes unique configuration information of each electronic component (e.g., including chips 100-101 in FIG. 1A) on the MDBA platform. The hash digest is then programmed into its dedicated fuse block of the master IHB chip (e.g., 125 in FIG. 1B) and the fuse block is then locked down to prevent any unwanted change (e.g., from third-party-inserted probing circuitry). A hash value, e.g., a SHA-256 entry, can be employed in the bonding process. Once MDBA platform completes the bonding process, IHB chip replacement may be prevented, because any unwanted change in the pre-configured connections between IHB components can be detected based on the programmed hash digest. In this way, the MDBA platform can be established as a virtual System on Chip (SoC) module.

The MDBA platform bonding/checking can be part of the MDBA platform Power-On-Self-Test (POST) process to verify whether the pre-configured connections between IHB components (e.g., including chips 100-101 in FIG. 1A) on the motherboard have not been changed. For example, after MDBA platform powers up, the master IHB chip may issue an IHB command broadcasting to each IHB controller for acquiring its UUID ciphertext encrypted by the transit key stored in the FUSE block 125. Once received, the master IHB chip may decrypt all the UUID ciphertext with its respective AES engine 126 within the IHB Security module 105 using the transit key stored in the FUSE block 125. The sequence of UUIDs listed in the data file may need to be consistent at the time of the hash computing for MDBA platform bonding. Once the UUID list has been assembled into a data file, the master IHB chip may compute the hash digest and compare it with the platform bonding value stored in the fuse block (e.g., see 125 in FIG. 1B) within the master IHB chip. If any inconsistency has been detected, third-party probing circuitry may have been inserted to intercept data on the motherboard, and the manufacturer may need to stop the booting of the MDBA platform.

When the motherboard of the device is initialized during an initialization phase 202, power-on MDBA platform security checking and authentication can be performed at 211. At each MDBA platform cold boot (e.g., when the power to the motherboard is physically turned off and turned on again), the first released IHB component (e.g., the master IHB chip) is responsible to validate all IHB connections on the platform to be consistently bonded. For example, the master IHB chip can get UUIDs from all IHB components on the motherboard/device as an addition to or after the completion of an existing IHB enumeration process. The advanced encryption standard (AES) engine (e.g., 126 in FIG. 1B) may encrypt the UUID with a 128-bit padding under an AES-ECB (electronic codebook) mode using the transit key that pre-programmed in the fuse block (e.g., 125 in FIG. 1B). The resulting encrypted data (e.g., in the form of cipher-text) can be used in the master IHB chip, or sent to the master IHB chip (e.g., when chip #0 100 is not the master IHB chip).

A master IHB chip, upon receiving the encrypted data from an electronic component, can decrypt it for each UUID packet, and have an on-chip security module (e.g., similar to the IHB security module 105) to compute the hash digest of the UUID data file. If the computed hash digest matches with the one-time programmed (OTP) hash value that is previously stored in the FUSE block 125 within the security module of the master IHB chip, the security checking is accomplished, and the master IHB chip can send each IHB connector an acknowledgement package to set a trusted bit (e.g., see 301 in FIG. 3B) to each IHB controller across the MDBA platform.

Upon initialization of the motherboard, the IHB security module (e.g., 105 in FIG. 1B) may initialize the encryption process by initializing the AES key setup and set initial counters for a scramble pattern generator at 213. At each MDBA platform cold boot, the master IHB chip can set up an AES encryption key denoted by IHB_Key (e.g., see 131 in FIG. 1B, can be 128-bit, etc.) generated by hardware entropy bit generator module as an example, which can be effective for the entire power cycle). The master IHB chip may also start a process for initializing all the transceiver counter values Sync_CNT_TX (e.g., 132 in FIG. 1B) and the receiver counter value Sync_CNT_RX (e.g., 133 in FIG. 1B) for each possible IHB connection within the MDBA platform. For example, the transceiver counter value of a transmitting component and the receiver counter value of a receiving component are to be synchronized such that data encryption and decryption can be performed because the two components are initialized at the same status.

The master IHB chip can invoke an on-chip security module (e.g., similar to the IHB security module 105) for generating a random pattern serving as the AES IHB_Key 131, and an initial pattern Sync_CNT (e.g. a 128-bit random value), and each IHB controller derives it to define initial sync counter values SYNC_CNT_TX and SYNC_CNT_RX 132 and 133 (128-bit) for generating the initial synchronization scramble patterns Sync_SP_TX/Sync_SP_RX 137/138 to protect the transceiver/receiver data communication across the MDBA platform. The security module may then encrypt the AES IHB_Key 131 and Sync_CNT pattern under the AES-ECB mode using the transit Key (located in fuse block 125). The encryption result is then sent to all IHB controllers within each IHB component across the MDBA platform.

Upon receiving the encrypted data packet from the master IHB component, each IHB controller can decrypt the data packet using the fuse transit key stored in the respective fuse block in the respective IHB component. Upon decryption, the restored IHB_Key 131 is loaded into the respective buffer 135.

To derive the initial counter values Sync_CTN_TX 132 and Sync_CTN_RX 133, each IHB controller may need to get its peer IHB component chip IDs, and generate a common counter values between two peer IHB chips to cover the dual communication channels. For example, in the respective example in FIGS. 1B-C, the initial synchronized counter value for chip #0 100 can be computed as:

Sync_CNT_TX=[Chip0_IHB_ID]∥[zero padding] XOR Sync_CNT
Sync_CNT_RX=[Chip1_IHB_ID]∥[zero padding] XOR Sync_CNT,
and the initial synchronized counter value for chip #1 101 can be computed as:
Sync_CNT_TX=[Chip1_IHB_ID]∥[zero padding] XOR Sync_CNT
Sync_CNT_RX=[Chip0_IHB_ID]∥[zero padding] XOR Sync_CNT.

During a runtime 203 of the motherboard of the device, all the packet frames communicated between two neighboring IHB chips are scrambled/de-scrambled by XOR logic operations (e.g., see 125a-b in FIG. 1B) over packet frame with the common scramble patterns dynamically generated by the TX/RX-scramble pattern generators 137-138 within a paired transceiver and a receiver at both ends of an IHB connection. For example, when a trusted IHB connection is established between two components (e.g., chip #0 100 transmits data packets to chip #1 101), the data packets are scrambled by the XOR logic 125a before transmitting to chip#1 101. The received packets at chip#1 101 are then de-scrambled at the XOR logic 156 as shown in FIG. 1C. The trusted connection requires both ends of the connection to start from a common counter value derived from Sync_CNT, i.e., the Sync_CNT_TX of the transceiver component (e.g., chip #0 100) equivalent to the receiver component's (e.g., chip #1 101) Sync_CNT_RX.

The trusted IHB connection may scramble all the data traffic (e.g., 141-142 in FIG. 1B) between the IHB components. All the link layer transceiver FIFO data frames 119a and the scrambling pattern 121 generated from the transceiver scramble pattern generator 137 are passed through an XOR gate 125a. Similarly, the receiving FIFO data frames are de-scrambled via the XOR gate 125b with the same pattern 122 generated at the receiver scramble pattern generator 138.

Each IHB controller 106 may generate a new synchronized scramble pattern immediately after the existing synchronized pattern has been taken to the scramble pattern generator 137-138. The updated synchronized scramble patterns can be computed independently by the transceiver and receiver between two IHB components of the IHB connection in the following way:

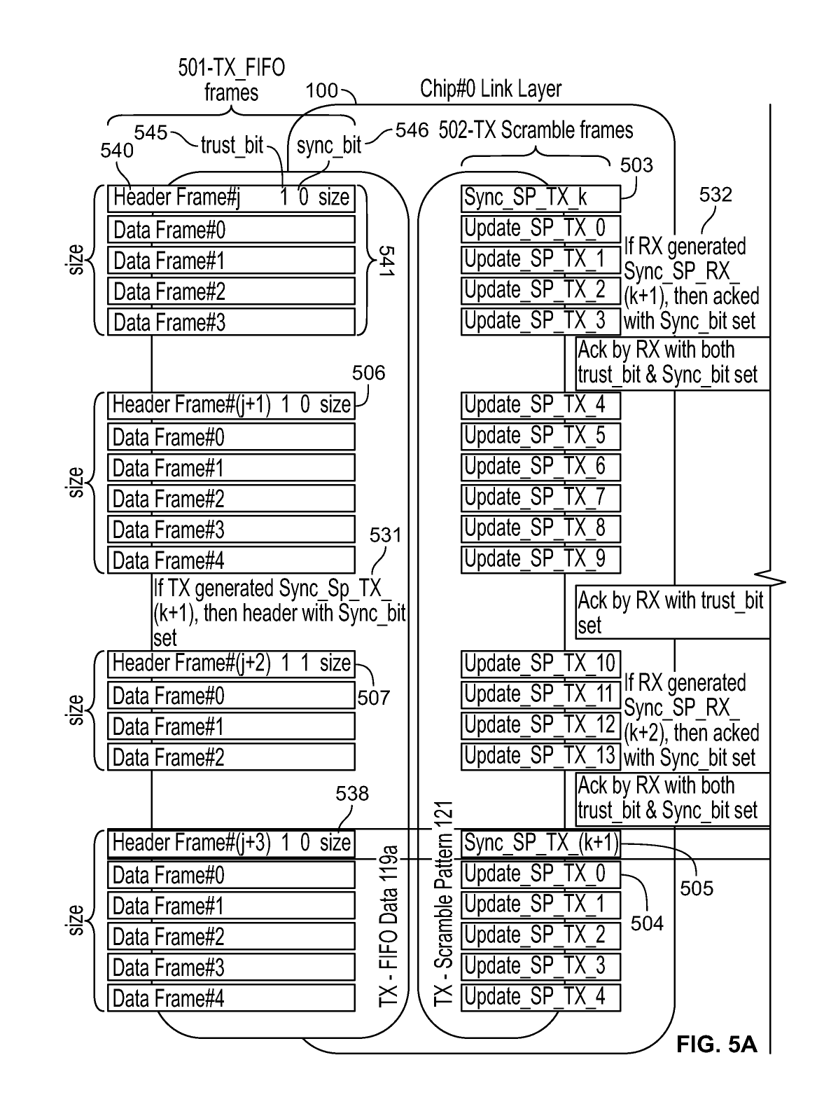

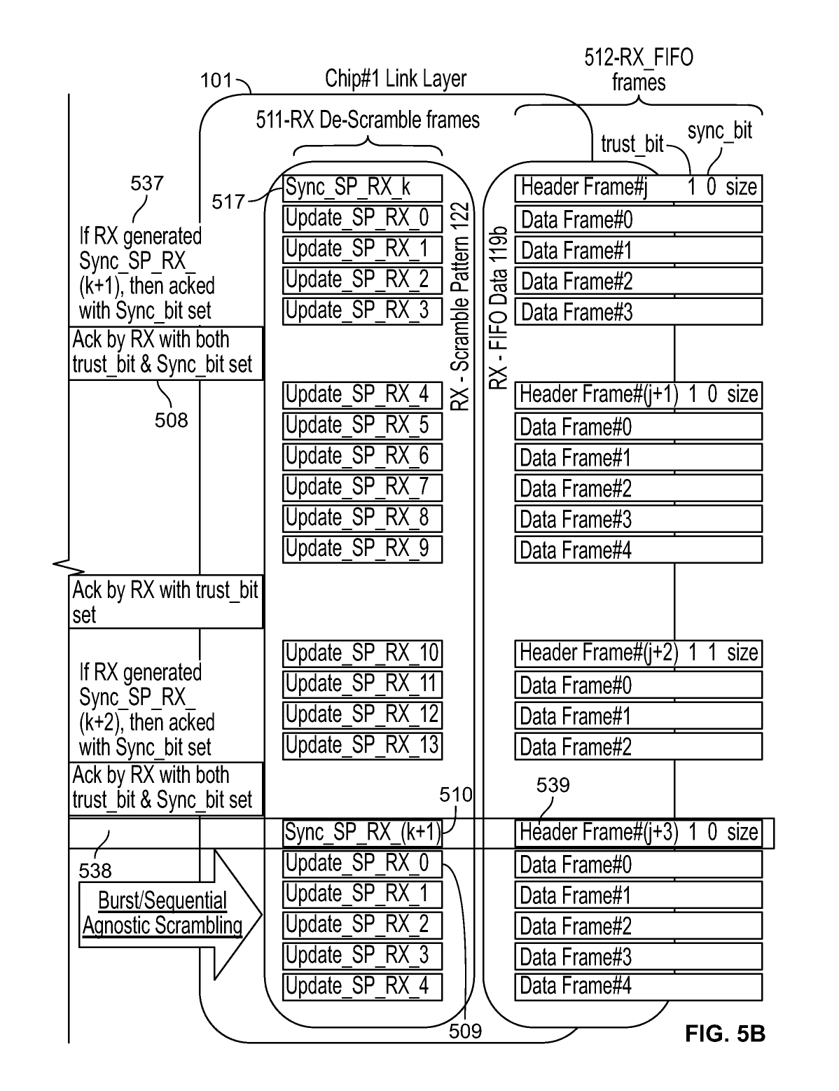

For the transceiver (e.g., at step 215), the transceiver counter 132 increases by 1, e.g., Sync_CNT_TX++; and then the synchronized scramble pattern for the transceiver is generated by encrypting the incremented Sync_CNT_TX under the AES-ECB mode using the IHB_key 131, e.g., Sync_SP_TX=AES_ECB(Sync_CNT_TX) using IHB_Key. Once Sync_SP_TX is generated, the transceiver may turn on the sync-bit in the next header packet frame (e.g., see 507 in FIG. 5A) that is being sent to the receiver.

Similarly, for the receiver (e.g., at step 217), the receiver counter 133 increases by 1, e.g., Sync_CNT_RX++; and then the synchronized scramble pattern for the receiver is generated by encrypting the incremented Sync_CNT_RX under the AES-ECB mode using the IHB_key 131, e.g., Sync_SP_RX=AES_ECB(Sync_CNT_RX) using IHB_Key. Once Sync_SP_RX is generated, the receiver may turn on the sync-bit in the next acknowledgment packet frame (e.g., see 508 in FIG. 5B) towards the transceiver.

Once the transceiver detects that sync-bit status has been established at both ends of the IHB connection, the TX IHB controller (e.g., 106 in FIG. 1B) may perform XOR operation over the header packet frame of TX FIFO data (e.g., 119a in FIG. 1B, which can be up to 128 bits) with the newly generated SYNC_SP_TX 505. Similarly, the receiver may also have detected the same sync-bit status at both ends and the RX IHB controller may wait until the next scrambled header packet frame from its peer is received, and de-scrambles the packet frame by performing XOR operation with the newly generated SYNC_SP_RX 510.

During the runtime of the device, to protect the subsequent data frame communication over IHB connection, the transceiver IHB controller may keep updating the scramble pattern Update_SP_TX using TX-Scramble Pattern Generator 137 to shuffle the scramble pattern initially defined by Sync_SP_TX, at a clock rate of TX_FIFO data 119a. The TX IHB controller then performs XOR operation over the newly updated scramble pattern 121 with FIFO data 119a to scramble TX data frame prior to CRC operation 126a. The scramble pattern within TX Scramble Pattern Generator 137 gets reset with Sync_SP_TX once TX IHB controller scrambles the header packet frame using newly created Sync_SP_TX 505.

On the other hand, the receiver IHB controller 155, in return, may perform in the same way to process the incoming subsequent scrambled data frames in order to successfully de-scramble the received data frames from the transceiver of IHB connection. For example, the receiver IHB controller keeps updating the scramble pattern Update_SP_RX using RX-Scramble Pattern Generator 138 to shuffle the scramble pattern initially defined by Sync_SP_RX, at a clock rate of RX_FIFO data 119b. The RX IHB controller then performs XOR operation over the newly updated scramble pattern 122 with data processed after CRC 126b as to de-scramble the data frame received. The scramble pattern within RX-Scramble Pattern Generator 138 gets reset with Sync_SP_RX once RX IHB controller de-scrambles the received header packet frame using newly created Sync_SP_RX 510. Thus, once the master IHB chip completes the MDBA platform bonding verification at POST, and securely delivered its newly created IHB_KEY and Sync_CNT to each individual IHB controller across the MDBA platform, all the security modules within IHB controllers can then be triggered to perform a runtime scramble pattern synchronization process as discussed above. The synchronized scramble patterns for the transceiver or the receiver can be regenerated to resynchronize the transceiver and the receiver periodically at 221, e.g., as shown in FIGS. 5A and 5B.

FIGS. 3A and 3B provide an example block diagram illustrating a modified IHB packet format for the enhanced IHB security in accordance with various embodiments of this disclosure. As shown in FIG. 3B, a trusted status bit 301 is inserted to the IHB packet to indicate whether the data packet is sent through a trusted connection between secured IHB components, e.g., the IHB components have been verified at the MDBA security checking at 211 in FIG. 2. Also a sync bit 302 may be inserted to the IHB packet as well to indicate whether the security module has computed a new sync scramble pattern and ready for use to resync the scramble pattern generator.

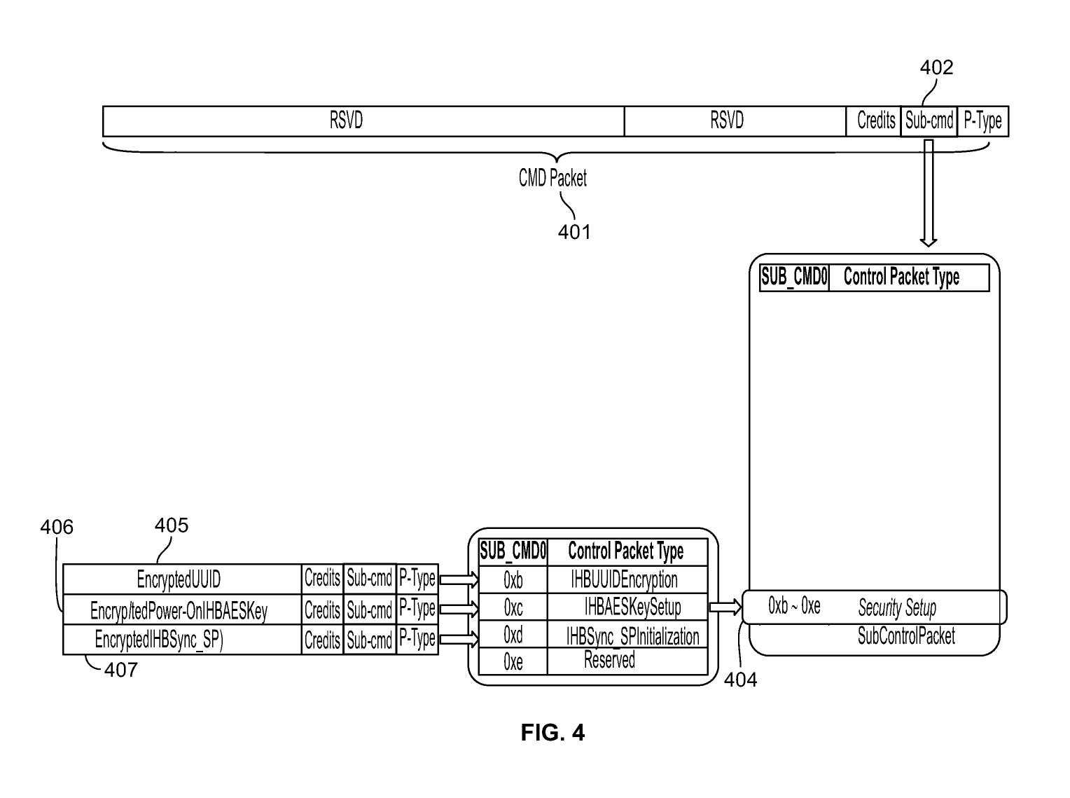

FIG. 4 provides an example block diagram illustrating the data format of an IHB command for security check, AES key setup and/or scramble pattern initialization in accordance with various embodiments of this disclosure. AS shown in FIG. 4, a sub-command segment 402 is added to the command packet 401. The encrypted UUID 405, encrypted power-on IHB AES key 406 and the encrypted IHB synchronized scramble pattern 407 can be stored in field 404 in the sub-command extension 402.

FIGS. 5A and 5B provides an example block diagram illustrating the example data structure of data packet frames during the scrambling process between two electronic components, e.g., chip #0 100 and chip #1 101 in accordance with various embodiments of this disclosure. As shown in FIG. 5A, data to be transmitted from the transceiver (e.g., 119a in FIG. 1B) includes a series of data packets TX_FIFO (either header frame 540 or data frames 541) 501 to be sent from chip #0 100 to chip #1 100. The header frame 540 may include a trust status bit trust bit 545 (e.g., similar to 301 in FIG. 3B) and a synchronization status bit sync bit 546 (e.g., similar to 302 in FIG. 3B).

In the respective example, chip #0 100 acts as a transceiver, and chip #1 101 link layer in FIG. 5B acts as a receiver. The transceiver chip #0 100 generates scramble patterns, e.g., similar to 121 in FIG. 1B. A number of transceiver scramble frames 502 can be generated at the transceiver chip #0 100. The synchronized scramble pattern Sync_SP_Tx 503 can be constantly, periodically or intermittently generated at a configured rate, to synchronize with the corresponding random pattern that is generated at the corresponding receiver (e.g., chip #1 101 in FIG. 5B), e.g., the synchronized descramble pattern Sync_SP_Rx 517 in FIG. 5B.

At step 531, once the TX security module (e.g., 105 in FIG. 1B) at the transceiver chip#0 100 generates the next sync scramble pattern Sync_SP_TX, the IHB controller (e.g., see 106 in FIG. 1B) may set the Sync bit in the next header frame 507. Correspondingly, at step 532 in FIG. 5A or 537 in FIG. 5B, upon detecting that an acknowledgement frame that indicates the RX has generated a matched sync scramble pattern 508 is received, the chip 0 100 link layer scrambles the next header frame 538 with the synchronized scramble pattern Sync_SP_Tx 505 by an XOR operation. In the meantime, the chip 0 100 link layer resets the transceiver scramble pattern generator (e.g., 137 in FIG. 1B) with a new synchronized scramble pattern Update_SP_Tx 504. The updated scramble pattern Update_SP_Tx 504 is then generated by the transceiver scramble pattern generator (e.g., 137 in FIG. 1B) at a rate matched with to the data rate of the TX-FIFO frames 501. In this way, so data packets issued from TX-FIFO 501 can be scrambled subsequently using the updated scramble pattern. In some implementations, the scramble patterns can be reset at a predetermined rate, which can be configured by the IHB controllers at either end of an IHB connection.

At the receiver chip 1 101, similarly, the synchronized scramble pattern Sync_SP_Rx 510 can also be regenerated at the rate configured by the receiver IHB controller, e.g., to synchronize with the transceiver. The receiver chip#1 101 may receive a number of data packet frames RX_FIFO 512 from the transceiver, and may generate de-scrambled frames 511. The receiver security module (e.g., 105 in FIG. 1B) may generate a synchronized scramble pattern internally using its AES crypto engine (e.g., 126 in FIG. 1B) with an IHB_Key to encrypt the counter value Sync_CNT_RX (e.g., 133 in FIG. 1B), which is incremented at each step. In this way, both the transceiver and the receiver can have the exact same random ciphertext value to be used as a synchronized scramble pattern. At step 537, upon the new synchronized pattern Sync_SP_RX 510 has been generated, the chip#1 IHB controller (e.g., 155 in FIG. 1B) may communicate it to the Chip#0 100 transceiver via an acknowledgement frame 508. At step 538, once chip#1 101 IHB controller identifies both transceiver and receiver of the IHB connection have established synchronized scramble patterns, the received next consecutive scrambled header frame 539 after CRC (e.g., 160 in FIG. 1B) may be de-scrambled with the new Sync_SP_RX 510 by XOR operation (e.g., 156 in FIG. 1B). The Chip 1 101 RX IHB controller may reset the receiver scramble pattern generator (e.g., 163 in FIG. 1B) with the new pattern Sync_SP_RX and activate it to generate a new sequence of Update_SP_RX 509. The updated scramble pattern Update_SP_RX 509 is then used to de-scramble the received data packets. The synchronized scramble pattern generation can be used for both burst and sequential agnostic scrambling, e.g., at 510.

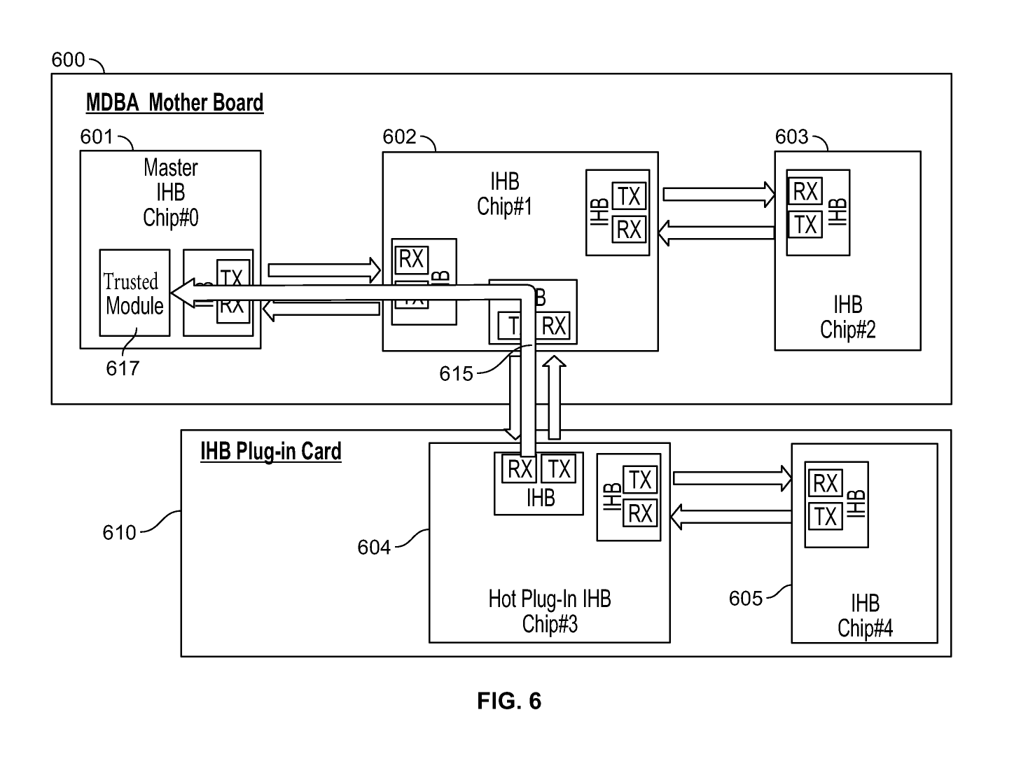

FIG. 6 provides an example block diagram illustrating an IHB security module available for hot plug-in in accordance with various embodiments of this disclosure. For example, for an MDBA motherboard 600 that hosts a master IHB chip #0 601, an IHB chip #1 602 and IHB chip #2 602, an IHB plug-in card 610 is added, bringing in new IHB components chip #3 604 and chip #4 605. Thus, the new chip #3 604 and chip #4 605 needs to be verified by the MDBA motherboard 600 to ensure security, e.g., no probing circuitry is attached with the new components. A dynamic bonding process can be performed via a public key infrastructure (PKI) with digital signature signed by the device manufacturer. For example, a trusted module 617 can be employed by the master IHB chip #0 601 such that the trusted module 617 receives a digital signature over a list of UUIDs of chip 604 and 605 signed by a trusted boot key, and verify whether the digital signature is valid. Upon verification, the hot plug-in chips, e.g., chip #3 604 and chip#4 605 may acquire the IHB-Key 131 and Sync_TX from the master IHB chip through the AES-ECB decryption with an OTP transit key of its IHB security module, furthermore, both chips may need to derive corresponding pair of Sync_CNT_TX and Sync_CNT_RX, to complete the setup for underlined IHB secure protocol in protecting their respective IHB communication, in a similar way that an on-board IHB component performs, as discussed in connection with FIG. 1B.

While various embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

The foregoing is merely illustrative of the principles of this disclosure, and various modifications can be made without departing from the scope of the present disclosure. The above-described embodiments of the present disclosure are presented for purposes of illustration and not of limitation, and the present disclosure is limited only by the claims that follow.

What is claimed is:

1. A method for secured data transfer via inter-chip hopping buses, the method comprising:
configuring a non-volatile storage element located within a first electronic component to be pre-programmed with a first unique identifier associated with a first electronic component;
configuring a first scramble pattern generator located within the first electronic component for generating a first scramble pattern based on a first counter value at runtime of the first electronic component; and
configuring a first XOR gate located within the first electronic component to receive the first scramble pattern from the first scramble pattern generator and data from a transceiver buffer for generating output data to be transmitted out of the first electronic component.

2. The method of claim 1, wherein the non-volatile storage element includes a fuse block or a one-time programmed element, and the non-volatile storage element is further pre-programmed with a common transit key during a manufacturing phase.

3. The method of claim 1, wherein the non-volatile storage element is further programmed with a hash digest computed based on the list of unique identifier (UUID) of all the IHB components within the device, and
after being programmed with the hash digest, the non-volatile storage element is locked to prevent unwanted change.

4. The method of claim 3, wherein the hash digest is used to authenticate all the electronic components and their connection within the device by comparing with a newly computed hash digest,
and wherein the authentication is performed during a manufacturing phase, a testing phase, or an initialization phase of the electronic components.

5. The method of claim 4, wherein the output data is received at a second electronic component communicatively coupled to the first electronic component via an inter-chip bus; and wherein the second electronic component comprises a second scramble pattern generator to generate a second scramble pattern based on a second counter value, wherein the second counter value is synchronized with the first counter value.

6. The method of claim 4, wherein the second electronic component further comprises:
a second XOR gate to receive the second scramble pattern from the second scramble pattern generator and data received from the first electronic component to generate output data to be enter a receiver buffer at the second electronic component.

7. The method of claim 4, wherein the second counter value is synchronized with the first counter value, and the second scramble pattern is synchronized with the first scramble pattern.

8. The method of claim 1, wherein the first scramble pattern is generated using a first encryption key.

9. The method of claim 1, wherein the first sync scramble pattern is cryptographically generated using a first encryption key with incremented synchronized counter values.

10. The method of claim 1, wherein the first scramble pattern generator periodically generates a new bit pattern when the first counter value reaches a pre-defined count, or intermittently generated at a configured rate

11. Circuitry for secured data transfer via inter-chip hopping buses, the circuitry comprising:
a non-volatile storage element to be pre-programmed with a first unique identifier associated with the first electronic component;
a first scramble pattern generator to generate a first scramble pattern based on a first counter value at runtime of the first electronic component; and
a first XOR gate to receive the first scramble pattern from the first scramble pattern generator and data from a transceiver buffer to generate output data to be transmitted out of the first electronic component.

12. The circuitry of claim 11, wherein the non-volatile storage element includes a fuse block or a one-time programmed element, and the non-volatile storage element is further pre-programmed with a common transit key during a manufacturing phase.

13. The circuitry of claim 11, wherein the non-volatile storage element is further programmed with a hash digest computed based on the first unique identifier, and
after being programmed with the hash digest, the non-volatile storage element is locked to prevent unwanted change.

14. The circuitry of claim 13, wherein the hash digest is used to authenticate the first electronic component by comparing with a newly computed hash digest,
and wherein the authentication is performed during a manufacturing phase, a testing phase, or an initialization phase of the first electronic component.

15. The circuitry of claim 14, wherein the output data is received at a second electronic component communicatively coupled to the first electronic component via an inter-chip bus; and wherein the second electronic component comprises a second scramble pattern generator to generate a second scramble pattern based on a second counter value, wherein the second counter value is synchronized with the first counter value.

16. The circuitry of claim 14, wherein the second electronic component further comprises:
a second XOR gate to receive the second scramble pattern from the second scramble pattern generator and data received from the first electronic component to generate output data to be enter a receiver buffer at the second electronic component.

17. The circuitry of claim 14, wherein the second counter value is synchronized with the first counter value, and the second scramble pattern is synchronized with the first scramble pattern.

18. The circuitry of claim 11, wherein the first scramble pattern is generated using a first encryption key.

19. The circuitry of claim 11, wherein the first scramble pattern generator periodically generate a new bit pattern when the first counter value reaches a pre-defined count.

20. The circuitry of claim 11, wherein the output data comprises a data packet that has a trusted status bit indicating the first electronic component has been authenticated.

21. A method for secured data transfer via inter-chip hopping buses, the method comprising:
configuring a non-volatile storage element located within an electronic component to be pre-programmed with a unique identifier associated with an electronic component and a transit key;
configuring a scramble pattern generator located within the electronic component for generating a scramble pattern based on a counter value at runtime of the electronic component;
configuring a transceiver component or a receiver component locate within the electronic component based on an inter-chip communication protocol to transmit a set of control packets to enforce security check and to setup inter-chip secure communication,
wherein the inter-chip communication protocol includes a set of signal bits defined in a header frame and an acknowledgement frame to establish a synchronized data scrambling mechanism for the scramble pattern generator;
configuring an encryption component located within the electronic component to encrypt the unique identifier using the transit key and to send the encrypted first unique identifier to another electronic component.

22. The method of claim 21, wherein the inter-chip communication protocol includes a public key infrastructure (PKI) scheme to establish secure communication channels, and wherein the PKI scheme supports real-time and on-demand addition of a new electronic component.
